(19) United States
(12) Patent Application Publication
(10) Pub. No.: US 2025/0279428 A1
(43) Pub. Date: Sep. 4, 2025

(54) NEXT-GENERATION LITHIUM-ION BATTERY AND ASSOCIATED MANUFACTURING METHOD

(71) Applicants: ECOLE POLYTECHNIQUE, Palaiseau Cedex (FR); CENTRE NATIONAL DE LA RECHERCHE SCIENTIFIQUE, Paris (FR)

(72) Inventors: Ileana FLOREA, Palaiseau Cedex (FR); Mariam EZZEDINE, Palaiseau Cedex (FR); Fatme JARDALI, Palaiseau Cedex (FR); Costel-Sorin COJOCARU, Palaiseau Cedex (FR)

(21) Appl. No.: 18/857,674

(22) PCT Filed: Apr. 19, 2023
(86) PCT No.: PCT/EP2023/060135

§ 371 Date: Oct. 17, 2024

(30) Foreign Application Priority Data
Apr. 20, 2022 (FR) 2203663

(51) Int. Cl. H01M 4/58; H01M 4/02; H01M 4/04; H01M 4/134; H01M 4/1397; H01M 4/38; H01M 10/0525; H01M 10/058

(52) U.S. Cl. CPC H01M 4/5825; H01M 4/0404; H01M 4/0428; H01M 4/0471; H01M 4/134; H01M 4/1397; H01M 4/386; H01M 10/0525; H01M 10/058; H01M 2004/021; H01M 2004/027; H01M 2004/028

(57) ABSTRACT

A cathode for a lithium-ion battery including a layer of a conductive material arranged to collect the current flowing through the cathode, which layer is referred to as the substrate of the cathode, a layer of aligned carbon nanotubes (CNTs) in electrical contact with the substrate of the cathode and mainly extending perpendicular to the substrate of the cathode, solid sulfur which at least partially coats an outer wall of the CNTs and a solid layer of solid lithium sulfate (Li₂SO₄), which layer is referred to as the outer layer of Li₂SO₄, covering the layer of CNTs so as to form a stack of layers in which the layer of CNTs is located between the substrate of the cathode and the outer layer of Li₂SO₄ is disclosed.

### TECHNICAL FIELD

The present invention belongs to the technical field of next-generation high-energy batteries.

The invention relates to a sulfur-based cathode for lithium-ion batteries, referred to as LIB. The invention relates in particular to a sulfur-based cathode for lithiated silicon-sulfur batteries.

Finally, the invention relates to the manufacturing method for such a cathode and such a battery.

### PRIOR ART

Among the various systems for storing energy in chemical form, the lithium-ion battery, referred to as LIB, has become the most popular over the last thirty years due to the energy and power that this type of device can deliver. This technology has been widely developed and is used in almost all mobile electronic applications as well as in the latest electric vehicles to the detriment of other rechargeable batteries.

Until now, most commercial lithium-ion batteries have used graphite as the anode material. Graphite has the advantage of being an inexpensive and highly abundant material. It also has high electrical conductivity and a theoretical specific capacity of 370 mAh/g.

Cathodes are mainly found in layer-structured lithium-ion batteries of the LiMO₂ type, where M is a metal such as nickel, iron, cobalt, manganese or a mixture of these metals. By way of example, the use of cathodes based on olivine LiMPO₄ or spinel LiM₂O₄ is known. Among these cathode materials, LiNi₁/3Mn₁/3CO₁/3O₂ is the most widely used cathode because of its lower cost, lower toxicity and better cycling stability even at high temperatures. This cathode has a theoretical specific capacity of around 100 mAh/g.

Today, the technology of LIBs has reached 87% of its commercially achievable energy density limit; acquiring the remaining 13% will be costly and slow with very limited returns on investment.

The current environmental and energy context and the limitations of lithium-ion batteries are driving the search for new battery technologies that are less expensive, have a lower ecological impact, do not require the use of problematic and rare metals such as cobalt, and deliver higher power and energy densities.

In order to increase the energy density of these electrochemical systems, one of the solutions is to maximize lithium storage in the host materials. This can be achieved by increasing the active material per unit area and using materials with a high storage capacity. The aim is to increase capacity, namely the number of charges (mAh) per unit of weight and/or volume.

One of the leading and most promising technologies envisaged for future generations of batteries is lithiated silicon-sulfur technology.

Sulfur (S) and Silicon (Si) are two attractive electrode materials for the future generation of batteries due to their abundance, high theoretical capacity and low cost.

For the positive electrode, also known as the cathode, sulfur offers the advantage of a high specific capacity (1675 mAh/g), six to ten times greater than that of cathodes currently used in commercial batteries.

For the negative electrode, also known as the anode, silicon offers the advantage of a high specific capacity (3579 mAh/g), ten times greater than that of the anodes currently used in commercial batteries.

However, during the discharge and charge cycle, the insertion of lithium into sulfur and silicon causes significant volumetric and therefore morphological variations of the order of 80 and 300%, respectively. These variations induce high mechanical stresses causing the active material to pulverize, resulting in a loss of capacity.

Moreover, for the sulfur cathode, the reduction of elemental sulfur leads to the formation of an intermediate chain of lithium polysulfides (Li₂Sₓ, 3<x<8) which are soluble in common organic electrolytes, causing long-term capacity degradation, slowing reaction kinetics during runtime and self-discharge of the battery.

Another problem with sulfur and silicon electrodes lies in their low electronic conductivity, which generally requires the addition of a significant quantity of electronic conductor to ensure good electronic percolation of the electrode.

This poses a technological challenge as maintaining the nominal specific capacity of such electrodes remains a major unsolved problem.

Current commercial electrode processes require the use of conductive polymer binders and/or carbon-based conductive additives. Binders and additives require the use of polluting and toxic chemical compounds.

The present invention aims to overcome, at least in part, the disadvantages of using sulfur and silicon in next-generation batteries.

A further aim of the invention is to provide a sulfur-based cathode:
having a higher specific energy than state-of-the-art sulfur-based cathodes, and/or
having a longer service life than state-of-the-art sulfur-based cathodes, and/or
that does not reduce, or reduces only slightly or less than state-of-the-art sulfur-based cathodes, during successive discharge and charge cycles, the charging efficiency and/or Coulombic efficiency of a battery wherein such a cathode is used, and/or
that does not result in, or results in only slight or less than state-of-the-art sulfur-based cathodes, during successive discharge and charge cycles, self-discharge of the accumulator and/or irreversible loss of capacity of a battery wherein such a cathode is used.

A further aim of the invention is to offer a lithiated silicon-sulfur type battery:
to overcome, at least in part, the disadvantages of LIBs, and/or
having a specific energy greater than 270 Wh/kg and/or
having a service life of at least 2000 charge/discharge cycles.

A further aim of the invention is to provide a method for manufacturing
a lithiated silicon-sulfur type battery:
to overcome, at least in part, the disadvantages of state-of-the-art LIB manufacturing methods, and/or
requiring no binder or additive to be used during electrode manufacture.

### PRESENTATION OF THE INVENTION

For this purpose, a cathode for a lithium-ion battery is proposed comprising:
a layer of a conductive material, preferably aluminum, arranged to collect the current flowing through the cathode, which layer is referred to as the substrate of the cathode,
a layer of aligned carbon nanotubes (CNTs) in electrical contact with the substrate of the cathode and mainly extending, preferably from one of the two ends thereof, perpendicular to the substrate of the cathode,
solid sulfur which coats, at least in part, an outer wall of the CNTs, and
a solid layer of lithium sulfate (Li₂SO₄), referred to as the outer layer of Li₂SO₄, covering, at least in part, preferably all, of the layer of CNTs so as to form a stack of layers wherein the layer of CNTs is comprised between the substrate of the cathode and the outer layer of Li₂SO₄, and/or
solid lithium sulfate (Li₂SO₄) encapsulating and/or enveloping, at least in part, the solid sulfur coating the outer walls of the CNTs.

Preferably, the solid sulfur forms a continuous or discontinuous layer, and/or of nanoparticles. The solid sulfur layer and/or nanoparticles have a thickness or, respectively, a diameter of less than 20 nm, preferably less than 10 nm. Preferably, a solid sulfur thickness of less than 20 nm has the effect of not significantly increasing the resistance of the solid sulfur layer and/or nanoparticles. Preferably, this effect is enhanced for sulfur thicknesses of less than 10 nm.

Preferably, Li₂SO₄ is electrolyte-permeable.

Preferably, Li₂SO₄ is impermeable to polysulfides.

Preferably, the outer layer of Li₂SO₄ and Li₂SO₄ covering the solid sulfur has the effect of maintaining or sequestering the polysulfides, formed by the reduction of solid sulfur when the cathode is in operation, in the cathode. In other words, the outer layer of Li₂SO₄ and the Li₂SO₄ covering the solid sulfur prevent the polysulfides from diffusing out of the cathode.

Preferably, lithium sulfate (Li₂SO₄) additionally covers and/or envelopes, at least in part, preferably only in part, the CNTs coating the outer walls of the CNTs.

Preferably, the outer layer of Li₂SO₄ has a thickness of less than 10 nm, preferably less than 8 nm, and/or greater than 3 nm.

The Li₂SO₄ encapsulating, at least in part, the solid sulfur and/or enveloping, at least in part, the CNTs may form a continuous or discontinuous film, referred to as the inner film layer of Li₂SO₄. The inner layer of Li₂SO₄ may extend, at least in part, into the layer of CNTs. Preferably, the inner film is a thin film. The thin film may have a thickness of less than 10 nm, preferably less than 8 nm.

Preferably, the solid sulfur may be any of the known allotropic forms of solid sulfur. Solid sulfur can have the formula Sn, where n is the number of sulfur atoms. Preferably, the solid sulfur can have a cyclic structure. As a nonlimiting example, the formula for solid sulfur may be S₆, S₈, S₉, S₁₀, S₁₂, S₁₈ or S₂₀. Preferably, the formula for solid sulfur is S₈.

According to the invention, a layer can be understood as a film.

Preferably, the layer of CNTs covers and/or is in contact, preferably directly, with the substrate of the cathode. Preferably, the substrate of the cathode is covered and/or is in contact, preferably directly, with a face or surface or side of the layer of CNTs located on the opposite side to the face or surface or side of the layer of CNTs in contact with the outer layer of Li₂SO₄.

Preferably, the cathode does not comprise a polymer binder or carbon additives.

Preferably, the layer of Li₂SO₄ prevents the diffusion of sulfur out of the cathode and/or the formation of polysulfide intermediates.

Preferably, the solid layer of Li₂SO₄ covers and/or is in contact, preferably directly, with the other end of the CNTs and/or with a face or surface or side, referred to as the outer face or surface or side, of the layer of CNTs located on the side opposite to the face or surface or side of the layer of CNTs in contact with the substrate of the cathode.

The layer of Li₂SO₄ can form a coating for the layer of CNTs.

Preferably, the solid layer of Li₂SO₄ forms an outer layer or interface of the cathode. Preferably, the outer layer or surface, formed by the solid layer of Li₂SO₄, is intended to be brought into contact with a porous element or an electrolyte-soaked separator in a lithium-ion cell.

Preferably, the layer of Li₂SO₄ has a thickness greater than 25 nm, preferably still 50 nm, more preferably 75 nm and even more preferably 100 nm and/or less than 2000 nm, preferably still 1000 nm, more preferably 750 nm and even more preferably 500 nm.

Preferably, the CNTs of the cathode:
have a length greater than 10 μm, preferably 30 um, and/or is less than 500 μm, preferably 250 μm, and/or
comprise between two and ten walls and/or, preferably, have a diameter between 4 and 16 nm, preferably comprise between three and five walls and/or, still preferably, have a diameter between 5 and 8 nm, and/or
have a density of between 1.1011 and 1.1012 tubes/cm².

The CNTs increase the specific surface area of the electrode and/or ensure rapid charge transfer between the layer of conductive material and the sulfur nanoparticles and/or give the electrode greater resistance to volume expansion without undergoing degradation and/or provide a highly conductive physical substrate.

Preferably, a sulfur mass loading of the Sa sulfur nanoparticles is greater than 1.5 mg/cm².

In the case of solid sulfur particles, the particles will swell and shrink significantly during consecutive charge/discharge cycles. According to the invention, the mass loading of sulfur nanoparticles is arranged so that the sulfur nanoparticles are sufficiently spaced due to their swelling. During discharge, the solid sulfur dissolves in the electrolyte then undergoes reduction and finally precipitates as lithium sulfide (Li₂S) in a cathode. Precipitation of Li₂S takes place at the interface with the electrolyte. The partial molar volume of Li₂S is 2.768×10⁻⁵ m³, while the partial molar volume of solid sulfur (S₈) is 1.239×10⁻⁴ m³/mol. Considering that each mole of solid sulfur can separate into eight moles of Li₂S, the complete conversion of one mole of S₈ into Li₂S occupies 76% more space. The low density of sulfur nanoparticles means that the size thereof varies little during consecutive charge/discharge cycles.

According to the invention, a lithium-ion battery, referred to as LIB, is also proposed, comprising the cathode according to the invention.

Preferably, the LIB does not comprise polymer binders or carbon additives.

Preferably, the LIB according to the invention is so-called “next generation”.

Coupling these two high-capacity electrodes, a silicon electrode (3579 mAh/g) and a sulfur electrode (1675 mAh/g), results in an average cell voltage of 2.15 V and a theoretical specific energy of 1982 Wh/kg (based on both electrodes), which is an order of magnitude higher than that of conventional LIBs.

Preferably, the LIB comprises:
an anode based on, or comprising, silicon nanoparticles, preferably grafted onto CNTs,
a porous element arranged between the cathode and the anode.

Preferably, the anode does not comprise a polymer binder or carbon additives.

Preferably, the silicon nanoparticles are composed of amorphous silicon. Preferably, the silicon nanoparticles have a size greater than 1 nm, preferably 2 nm, still preferably 5 nm and/or less than 50 nm, preferably 40 nm, still preferably 30 nm.

Preferably, the porous element is a membrane. The porous element can be formed by a stack of two distinct layers.

Preferably, the anode of the LIB comprises:
a layer of conductive material, preferably copper, arranged to collect the current flowing through the anode, which layer is referred to as the substrate of the anode,
a layer of aligned carbon nanotubes (CNTs) in electrical contact with the substrate of the anode and mainly extending, preferably from one end thereof, perpendicular to said substrate of the anode,
silicon nanoparticles that coat, at least, preferably only, the outer wall of at least some of the CNTs, preferably the outer wall of the CNTs.

Preferably, the layer of CNTs covers and/or is in contact, preferably directly, with the substrate of the anode. Preferably, the substrate of the anode is covered and/or is in contact, preferably directly, with a face or surface or side of the layer of CNTs located on the side opposite to the face or surface or side, referred to as the outer face or surface or side, of the layer of CNTs intended to be in contact with the porous element.

Preferably, the porous element covers and/or is in contact, preferably directly, with the other end of the CNTs and/or with the outer face of the layer of CNTs located on the side opposite to the face or surface or side of the layer of CNTs in contact with the substrate of the cathode.

Preferably, the size of the silicon nanoparticles is greater than 2 nm, still preferably 5 nm and/or is less than 50 nm, still preferably 40 nm and even more preferably 30 nm.

Preferably, a silicon mass loading of the silicon nanoparticles of the an-ode is greater than or equal to 2 mg/cm². Preferably, the silicon mass loading of the silicon nanoparticles of the anode is greater than or equal to 0.01 mg/cm², still preferably 0.1 mg/cm², preferably 1 mg/cm², more preferably 2 mg/cm², still more preferably 2.5 mg/cm², particularly preferably 3 mg/cm², even more particularly preferably 3.5 and most preferably of all 4 mg/cm². Preferably, the silicon mass loading of the silicon nanoparticles of the anode is less than or equal to 5 mg/cm². Preferably, the silicon mass loading of the silicon nanoparticles of the anode is equal to 4.5 mg/cm².

According to the invention, a method is also proposed for manufacturing a cathode, preferably a cathode according to the invention, preferably still a cathode for, or intended to be integrated into, a lithium-ion battery, referred to as LIB, more preferably in an LIB according to the invention. The method comprising the steps of:
obtaining, or providing, an electrode, referred to as the electrode obtaining step, comprising a layer of a conductive material, arranged to collect the current flowing through the cathode, referred to as the substrate of the electrode, from which extends, mainly perpendicularly, a layer of aligned carbon nanotubes (CNTs) in electrical contact with the substrate of the electrode, then
covering or depositing on a face or surface or a side of the layer of CNTs, located on the side opposite to a face or surface or a side, referred to as the outer face or surface or side, of the layer of CNTs in electrical contact with the substrate of the electrode, with a solution, referred to as the sulfur solution, comprising solid sulfur to form a coating, or covering or coating or grafting or lining or forming a coating, of solid sulfur which coats, at least part of an outer wall of the CNTs, then
covering with or depositing on the outer face of the layer of CNTs a solution comprising dissolved lithium sulfate (Li₂SO₄) to form a solid layer of solid lithium sulfate (Li₂SO₄) covering the layer of CNTs.

Preferably, the step of covering the face of the layer of CNTs, located on the side opposite to the face of the layer of CNTs in electrical contact with the substrate of the electrode, with the Li₂SO₄ solution may consist of depositing a drop or a film or a thin layer of the Li₂SO₄ solution on the face of the layer of CNTs, located on the side opposite to the face of the layer of CNTs in electrical contact with the substrate of the electrode.

Preferably, the Li₂SO₄ solution is an aqueous solution of Li₂SO₄.

Preferably, prior to the step of forming the solid layer of Li₂SO₄, the method comprises a step of drying the sulfur solution coating, at least in part, the outer wall of the CNTs. Preferably, prior to the step of drying the sulfur solution, the method comprises a cathode rinsing step, preferably a step of rinsing the sulfur solution deposited on the outer face of the layer of CNTs.

Preferably, the method comprises, subsequent to the step of coating the face of the layer of CNTs with the solution comprising dissolved Li₂SO₄, a step of drying the Li₂SO₄. Preferably, the method comprises, prior to the step of drying the Li₂SO₄.

Preferably, the step of covering the outer face of the layer of CNTs with the sulfur solution and/or with the solution comprising dissolved Li₂SO₄ comprises a step of penetrating said solution into the layer of CNTs in the direction of the substrate, preferably even as far as the substrate.

Preferably, the step of penetrating the sulfur solution into the layer of CNTs has the effect of encapsulating and/or enveloping, at least in part, the solid sulfur which coats the outer walls of the CNTs with solid lithium sulfate (Li₂SO₄).

Preferably, the sulfur solution further comprises a solid sulfur powder, which may contain or consist of solid sulfur nanoparticles, a polar solvent, preferably aprotic or protic, still preferably isopropyl alcohol and/or N-methyl-2-pyrolidone, and carbon disulfide.

These solvents are listed by way of example. There are other suitable solvents which the skilled person will be able to select.

Preferably, a volume ratio, V_{SCS}/V_{SP}, between a volume of carbon disulfide, noted V_{SCS}, and a volume of polar solvent, noted V_{SP}, is between 10 and 30%. Preferably, the V_{SCS}/V_{SP} volume ratio is greater than or equal to 10%, preferably 12%, still preferably 14%, preferably 15%, more preferably 16%, even more preferably 18% and most preferably of all 20%. Preferably, the V_{SCS}/V_{SP} volume ratio is less than or equal to 30%, preferably 28%, still preferably 26%, preferably 25%, more preferably 24%, even more preferably 22% and most preferably of all 20%.

Preferably, the method of manufacturing a cathode comprises the step, referred to as plasma treatment, of treating the CNTs of the electrode, preferably treating the electrode, with a cold or a thermal plasma and/or a water vapor plasma; the plasma treatment step is carried out prior to the step of covering the layer of CNTs with the sulfur solution and subsequently to the step of obtaining the electrode.

The plasma treatment step creates defects on the outer wall of the CNTs. By way of example, the treatment step can be carried out by ion irradiation.

Preferably, the plasma treatment step further comprises accelerating, by polarization, all or some of the species present in the plasma towards the electrode.

Preferably, the step of obtaining the electrode comprises a step of synthesizing CNTs on the substrate of the electrode by hot-filament chemical vapor deposition, said synthesis step comprises:
arranging the substrate of the electrode equidistant from four aligned, preferably longitudinally, hot filaments,
flushing a gas, comprising precursors, parallel to the hot filaments.

Preferably, the gas comprising the precursors comprises gaseous hydrogen and gaseous carbonaceous precursors, such as for example, methane and/or acetylene, ethylene, propan-2-ol and carbon monoxide.

Preferably, the method comprises, prior to the step of synthesizing CNTs, a step of depositing a layer, referred to as a barrier layer, with a thickness of between 5 and 80 nm, preferably between 10 and 50 nm, of aluminum oxide (Al₂O₃) deposited on the substrate of the electrode and an iron layer, referred to as a catalyst layer, deposited on the barrier layer, with a thickness of between 1 and 30 nm.

The method for manufacturing the cathode according to the invention is particularly suitable, preferably even specially designed, for implementing the cathode according to the invention. Thus, any feature of the method for manufacturing the cathode according to the invention can be integrated into the cathode according to the invention and vice versa.

According to the invention, a method for manufacturing a lithium-ion battery, referred to as LIB, is also proposed comprising the steps consisting of:
implementing the method for manufacturing a cathode according to the invention,
obtaining or supplying an anode for the LIB,
assembling the LIB by interposing a porous element between the cathode and the anode.

Preferably, the method for manufacturing an LIB comprises the step of sealing, in an oxygen gas-free environment, the cathode, the porous element and the anode to form the LIB.

Preferably, the method for manufacturing an LIB comprises the step of soaking the porous element with electrolyte.

The method for manufacturing the LIB according to the invention is particularly suitable, preferably even specially designed, for implementing the LIB according to the invention. Thus, any feature of the method for manufacturing the LIB according to the invention can be integrated into the LIB according to the invention and vice versa.

### DESCRIPTION OF FIGURES

Other benefits and features shall become evident upon examining the detailed description of entirely non-limiting embodiments and implementations, and from the following enclosed drawings:

FIG. 1 shows three scanning electron microscopy images of three nanostructured current collectors according to the invention, whose vertically aligned carbon nanotube surfaces have thicknesses of 30, 60 and 150 μm,

FIG. 2 is a transmission electron microscopy image of carbon nanotubes of one embodiment of a cathode whose carbon nanotubes are coated with solid sulfur and a schematic representation of such an electrode whose carbon nanotubes are coated with solid sulfur,

FIG. 3 is a scanning electron microscopy image of part of the silicon nanoparticle-coated carbon nanotube film of one embodiment of an anode according to the invention and a schematic representation of such an anode,

FIG. 4 is a transmission electron microscopy image of carbon nanotubes of one embodiment of a cathode whose carbon nanotubes are coated with a solid layer of solid lithium sulfate and a schematic representation of a cathode according to the invention,

FIG. 5 is a schematic representation of a lithium-ion battery according to the invention,

FIG. 6 is a graph showing the evolution of the specific capacity and surface capacity of cathode 1 against metallic lithium according to the invention for 500 discharge cycles at a discharge rate of C/3,

FIG. 7 is a graph showing the evolution of the specific capacity and surface capacity of cathode 1 against metallic lithium according to the invention for 1000 discharge cycles at a discharge rate of 2C,

FIG. 8 is a graph showing the specific capacity of anodes 3 according to the invention having different silicon mass loadings, against metallic lithium, for 6 discharge cycles at a discharge rate of C/20,

FIG. 9 is a graph showing the evolution of the specific capacity and Coulombic efficiency of anode 3 against metallic lithium according to the invention for 2000 discharge cycles at a discharge rate of C/20 and C/5,

FIG. 10 is a graph showing the specific capacity and surface capacity of a lithium-ion battery according to the invention at a charge rate of C/20,

FIG. 11 is a graph showing the energy density of a lithium-ion battery according to the invention at a charge rate of C/20.

### DESCRIPTION OF THE EMBODIMENTS

The embodiments are described below are in no way limiting, and in particular, it is possible to consider variants of the invention that comprise only a selection of the features disclosed, in isolation from the other features disclosed (even if that selection is isolated within a phrase comprising other features), if this selection of features is sufficient to confer a technical benefit or to differentiate the invention with respect to the prior state of the art. This selection comprises at least one preferably functional feature which lacks structural detail, or only has a portion of the structural details if that portion only is sufficient to confer a technical benefit or to differentiate the invention with respect to the prior state of the art.

With reference to FIGS. 1 to 11, one embodiment of the invention is described.

With reference to FIGS. 1 to 5, a cathode 1 according to the invention for lithium-ion batteries (LIBs) is presented. The cathode 1 comprises a layer 41 of a conductive material arranged to collect the current flowing through the cathode 1, referred to as the substrate 41 of the cathode 1. According to the embodiment, the conductive material is aluminum. The cathode comprises a layer 51 of aligned carbon nanotubes (CNTs) 9 in electrical contact with the substrate 41 of the cathode 1. The CNTs 9 mainly extend, from one of the ends thereof, referred to as the proximal end, perpendicular to the substrate 41 of the cathode 1. The CNTs 9 according to the invention are multi-walled and comprise at least one wall.

With reference to FIGS. 1 to 5, the CNTs 9 comprise between three and five walls with a diameter of between 5 and 8 nm. The CNTs 9 according to the embodiment have a length of between 30 and 200 μm.

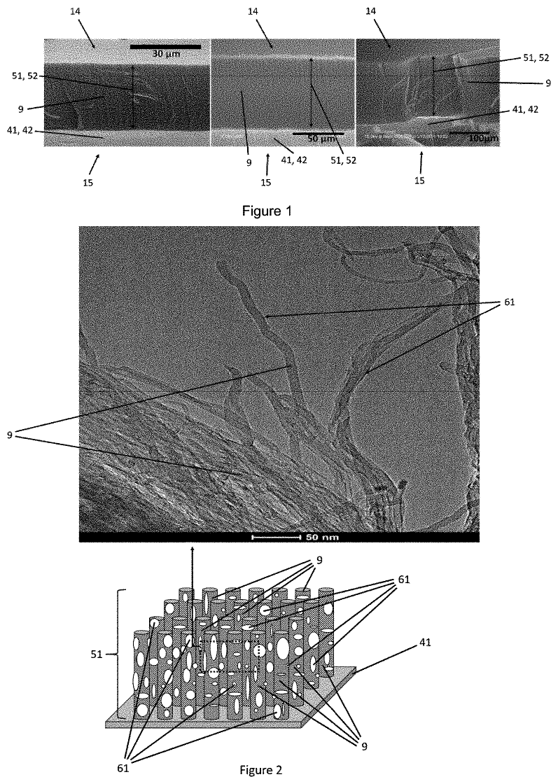

The cathode 1 comprises solid sulfur 61 which at least partially coats an outer wall of the CNTs 9. As shown in FIG. 2, the solid sulfur 61 can form a discontinuous thin film. However, depending on the conditions under which the solid sulfur 61 is deposited, it may form an almost-continuous film. The solid sulfur 61 has a thickness of around 5 to 10 nm according to the embodiment. The thin layer of solid sulfur 61 on the surface of the CNTs 9 makes the solid sulfur 61 difficult to image by scanning electron microscopy. According to the non-limiting embodiment, the solid sulfur 61 is S& sulfur or cyclooctasulfur forming a discontinuous thin film.

The cathode 1 also comprises a solid layer 7 of solid lithium sulfate (Li₂SO₄), referred to as the outer layer 7 of Li₂SO₄, covering the layer 51 of CNTs 9 so as to form a stack of layers wherein the layer 51 of CNTs 9 is comprised between the substrate 41 of the cathode 1 and the outer layer 7 of Li₂SO₄. The outer layer 7 covers the other end, referred to as the distal end, of the CNTs 9. The effect of this layer 7 is to prevent the diffusion of lithium polysulfides, formed by the reduction of elemental sulfur, into the electrolyte during cycling, out of the cathode 1, when the latter is operating within an LIB. Advantageously, according to the embodiment, the solid layer 7 is continuous and covers the layer 51 of CNTs 9. The thickness of the outer layer 7 is estimated as being between 1000 and 2000 nm according to the embodiment.

Although, by adjusting the Li₂SO₄ deposition conditions, cathode 1 may comprise only the outer layer 7 of Li₂SO₄; preferably, cathode 1 also comprises Li₂SO₄, referred to as protective film 8, encapsulating and/or enveloping, at least in part, the solid sulfur 61 which coats the outer walls of the CNTs 9. The thickness of the protective film 8 is estimated at between 3 and 8 nm according to the embodiment. The protective film 8 of Li₂SO₄ has the effect of preventing the diffusion of lithium polysulfides into the electrolyte contained in cathode 1 when this latter is operating within an LIB.

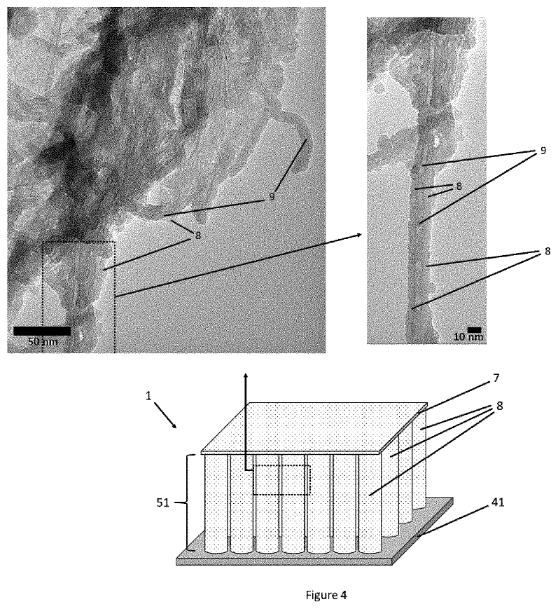

With reference to the schematic representation in FIG. 4, the protective film 8 of Li₂SO₄ is shown as forming a continuous layer completely coating the solid sulfur 61 and the CNTs 9. However, depending on the Li₂SO₄ deposition conditions, the protective film 8 of Li₂SO₄ may be almost-continuous or discontinuous. It may form solid plates 8 of Li₂SO₄ or a discontinuous solid film 8 of Li₂SO₄ partially coating the CNTs 9 and partially the solid sulfur 61. In this case, although it offers less protection against the diffusion of lithium polysulfides in the electrolyte, its effect is still significant. The discontinuous solid film 8 of Li₂SO₄ partially coating the CNTs 9 and partially the solid sulfur 61 encapsulates and/or envelops, at least partially, the solid sulfur 61 which coats the outer walls of the CNTs 9. With reference to the transmission electron microscopy image in FIG. 4, the protective film 8 of Li₂SO₄ can be seen forming a continuous layer completely coating the CNTs 9.

The cathode 1 according to the invention has a mass loading of solid sulfur 61 which is greater than 1.5 mg/cm². The mass loading of solid sulfur 61 of the cathode 1 shown in FIG. 2 is estimated at 2 mg/cm². The mass loading can be adjusted by modifying the operating conditions of cathode 1 as described in the part relating to the method according to the invention. Increasing the mass loading improves the performance of cathode 1 and therefore of an LIB comprising such a cathode 1. There is an upper limit to the mass loading per unit area which improves the performance of the cathode 1. This limit is determined by the density of the CNTs 9 on the substrate 41, that is, the distance between the CNTs 9, the length and/or thickness of the CNTs 9 and by the volume expansion of solid sulfur 61 during the charge/discharge cycles.

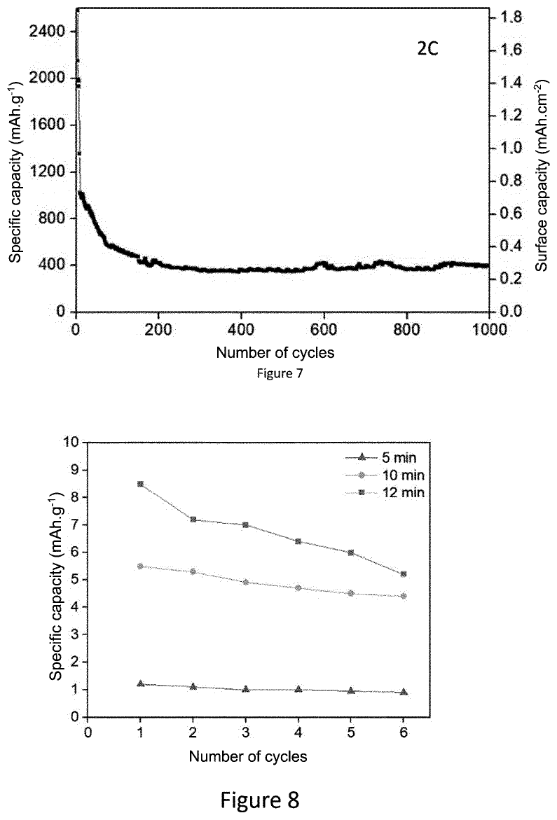

With reference to FIG. 6, the evolution of the specific capacity and the surface capacity of cathode 1 is shown according to the invention for 500 discharge cycles at a discharge rate of C/3. Note that cathode 1 has a specific capacity stabilizing at a value above 500 mAh.g⁻¹. The performance of cathode 1 according to the invention, at a discharge rate of C/3, is therefore 2.6 times higher than that of commercial Li-ion batteries. With reference to FIG. 7, the evolution of the specific capacity and the surface capacity of cathode 1 is shown according to the invention for 1000 discharge cycles at a discharge rate of 2C. Note that cathode 1 has a specific capacity stabilizing at a value above the order of 400 mAh.g⁻¹. The performance of cathode 1 according to the invention, at a discharge rate of 2C, is therefore 2.2 times higher than that of commercial Li-ion batteries.

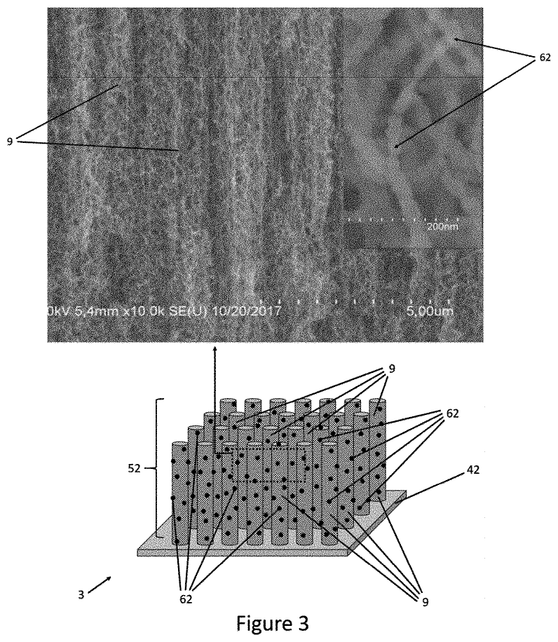

According to the embodiment, with reference to FIG. 3, an anode 3 based on silicon nanoparticles 62 (NPs) is also described.

The anode 3 comprises a layer 42 of a conductive material arranged to collect the current flowing through the anode 3, which layer is referred to as the substrate 42 of the anode 3. The conductive material is copper according to the embodiment. The anode 3 comprises a layer 52 of aligned CNTs 9 in electrical contact with the substrate 42 of the anode 3. The CNTs 9 mainly extend, from one of the ends thereof, perpendicular to the substrate 42 of the anode 3.

The NPs 62 of the anode 3 coat the outer wall of the CNTs 9. The size of the silicon NPs 62 is between 5 and 30 nm according to the embodiment.

The anode 3 according to the invention, preferably, has a silicon mass loading which is greater than 2 mg/cm². The mass loading can be adjusted by modifying the operating conditions of anode 3 as described in the part relating to the method according to the invention. With reference to FIG. 8, the specific capacity is shown of the anodes 3 according to the invention having silicon mass loadings of 0.2, 2.5 and 4 mg/cm². It can be seen that increasing the mass loading improves the specific capacity of anode 3 and therefore the performance of anode 3 and therefore of an LIB 10 comprising such an anode 3. As mentioned for cathode 1, there is an upper limit to the mass loading per unit area which improves the performance of anode 3.

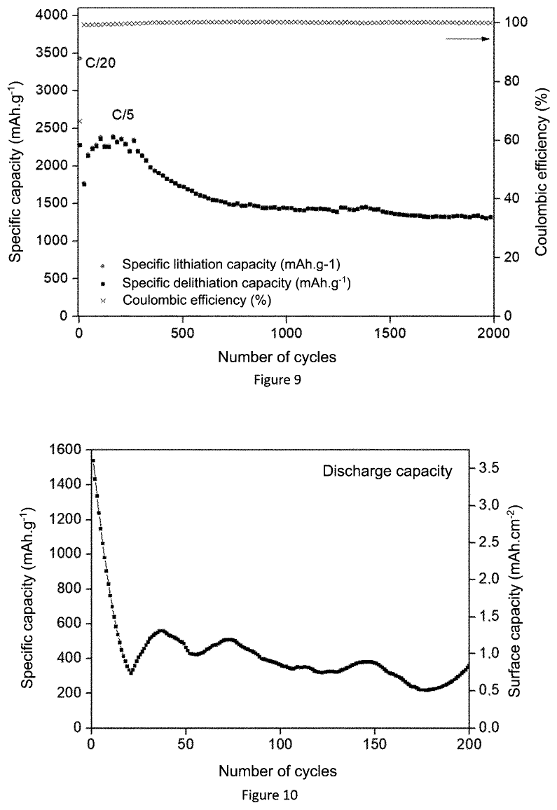

With reference to FIG. 9, the evolution of the specific capacity and Coulombic efficiency of anode 3 according to the invention is shown, having a silicon mass loading of 0.03 mg/cm², for 2000 discharge cycles at a discharge rate of C/20 and C/5. Note that anode 3 has a specific capacity stabilizing at a value greater than 1250 mAh.g⁻¹. Coulombic efficiency has a stable value of around 100%. The performance of anode 3 according to the invention, at a discharge rate of C/5, is therefore 3.6 times higher than that of commercial Li-ion batteries.

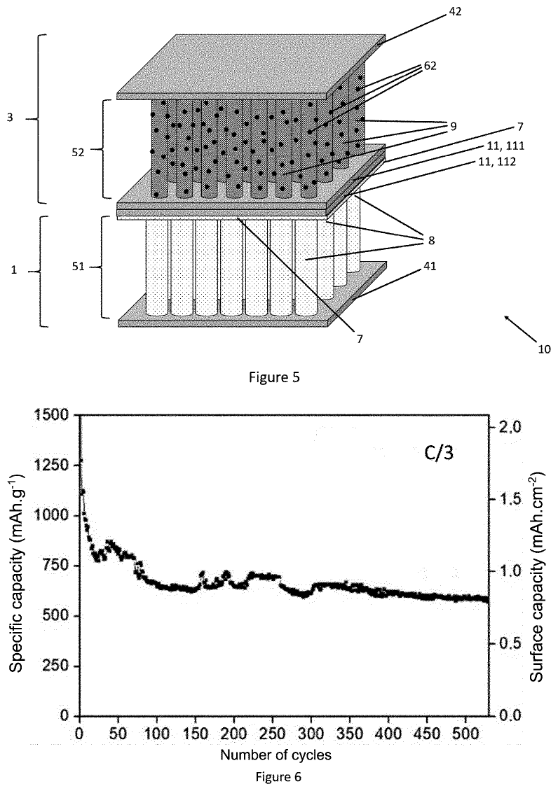

According to the embodiment, with reference to FIG. 5, a LIB 10 comprising the cathode 1 according to the invention is also described. Although the cathode 1 according to the invention can be mounted in an LIB with any anode; according to the embodiment, the cathode 1 is mounted with the anode 3 according to the embodiment.

According to the embodiment, the LIB 10 is a button cell in CR2032 format comprising a porous element 111, 112 formed by a stack 11 of two layers 111, 112 interposed between the anode 3 and the cathode 1. The stack 11 comprises a layer 111, or spacer, which is made of glass microfiber, sold under the trade name Glass Microfiber Filter by the manufacturer Whatman®, with a thickness of 675 μm, a diameter of 16.5 mm and a retention threshold of 2.7 μm. The other layer 112 of the stack 11, or separator, with a thickness of 25 μm is made of microporous polypropylene sold under the trade name Celgard 2400 by the manufacturer Celgard®.

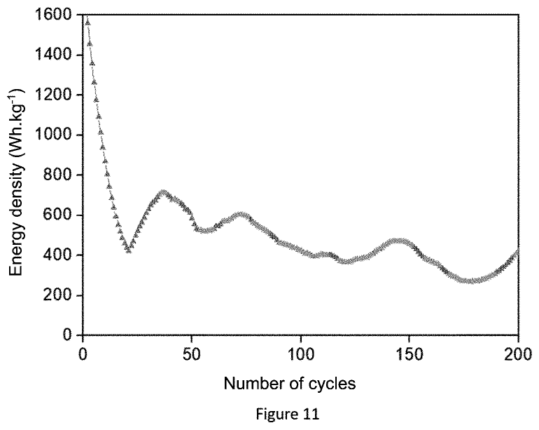

FIGS. 10 and 11 show the performance of the LIB 10 according to the invention. The mass loading of sulfur and silicon of cathode 1 and anode 3 is 1 mg/cm². The cycles are run at a charge rate of C/20. A stable discharge capacity greater than 300 mAh/g is achieved after 100 cycles. The LIB 10 has an energy density of around 750 Wh.kg⁻¹. This energy density value is three times higher than that of commercial lithium-ion batteries.

According to the embodiment, it is also an embodiment of a method for manufacturing a cathode 1 according to the invention. The method comprising the step of obtaining an electrode 15, referred to as the electrode 15 obtaining step, as shown in FIG. 1. This step may involve procuring the electrode 15 or purchasing a commercial electrode 15. With reference to FIG. 1, the electrode 15 comprises a layer 41 of a conductive material, of aluminum according to the embodiment, arranged to collect the current flowing through cathode 1, which layer is referred to as the substrate 41 of the electrode 15. The electrode 15 comprises a layer 51 of aligned CNTs 9 extending, mainly perpendicular, from the substrate 41. The CNTs 9 are in electrical contact, by one end thereof, with the substrate 41 of the electrode 15.

The method further comprises the step of covering the outer face 14 of the layer 51 of CNTs 9 with a sulfur solution comprising solid sulfur to form the coating of solid sulfur 61 coating the outer wall of the CNTs 9 as shown in FIG. 2. The outer face 14 of the layer 51 of CNTs 9 is located on the side opposite to the face of the layer 51 of CNTs 9 in electrical contact with the substrate 41 of the electrode 15.

The method comprises the step of covering the outer face 14 of the layer 51 of CNTs 9 with a solution comprising Li₂SO₄ to form the layer 8 of Li₂SO₄, that is, the protective film 8 of Li₂SO₄, covering the layer 51 of CNTs 9. According to the non-limiting embodiment, the solution comprising Li₂SO₄ is an aqueous solution, of distilled water and isopropyl alcohol, wherein Li₂SO₄ is dissolved at a concentration of 1 mol. L⁻¹.

According to the non-limiting embodiment, the step of covering the outer face 14 of the layer 51 of CNTs 9 with the solution comprising Li₂SO₄ comprises infiltrating the solution comprising Li₂SO₄ into the layer 51 of CNTs 9. Infiltration of the solution containing Li₂SO₄ into the layer 51 of CNTs 9 allows a solid film 8 to form, which may be discontinuous, of Li₂SO₄ coating, at least in part, the CNTs 9 and the solid sulfur 61.

According to the embodiment, the step of forming the coating of solid sulfur 61 coating the outer wall of the CNTs 9 comprises infiltrating the sulfur solution into the layer 51 of CNTs 9. The sulfur solution is composed of sulfur S₈ (Sigma Aldrich) or cyclooctasulfur in a solution comprising carbon disulfide (CS₂) with isopropyl alcohol (IPA) or with N-methyl-2-pyrrolidone (NMP) in a volume ratio between (7:3) and (9:1). Then, the CNTs 9 are washed several times with dilute sulfur solutions. The CNTs 9 are then dried, for example in an oven, at 40° C. for between 4 and 8 hours.

According to a non-limiting embodiment, a method is proposed for manufacturing the anode 3 according to the embodiment. The method of obtaining step of obtaining the electrode 15 described above. The NPs 62 are deposited on the CNTs 9 by chemical vapor deposition (CVD) in a gas stream using a dilute silane precursor (SiH₄) mixed with dihydrogen (H₂). The substrate 42 is loaded into a CVD reactor preheated to 540° C. which is flushed with H₂ at a flow rate of 30 cubic centimeters per minute (sccm). Alternatively, a gaseous mixture of SiH₄ at a concentration of 1% diluted in dinitrogen (N₂) can be used. In this case, it is possible to work up to ambient pressure.

After heating the substrate 42 for 3 to 10 minutes, the SiH₄ is introduced into the CVD reactor at a flow rate of 10 sccm and a tungsten filament placed at the H₂ inlet in the reactor is heated to around 1000° C. (at a power of between 70 and 80 W). Atomic hydrogen is thus generated to etch excess silicon on the surface of the CNTs 9 and improve the deposition and homogeneity of the NPs 62 along the entire length of the CNTs 9.

The pressure inside the reactor is maintained at 5 mbar with a partial pressure of SiH₄ of between 1 and 5 mbar. Synthesis time ranges from 1 to 15 minutes, depending on the size of silicon NPs 62 sought. At the end of the process, the resulting electrode 15 is moved to a cooling zone in the reactor and removed from the reactor once it has cooled down completely. The diameter of the NPs 62 is between 5 nm and 30 nm for deposition times of between 3 minutes and 15 minutes. After 10 minutes, a silicon layer begins to form. The homogeneity and density of the deposition of the NPs 62 can be adjusted by modifying the parameters associated with deposition time, gas flow and hot filament power.

According to one embodiment, a step of generating defects on the CNTs 9 is proposed. According to the non-limiting example shown, this step is carried out by plasma treatment. Prior to manufacturing the anode 3, the cathode 1 or the LIB 10, the electrode 15 is exposed to a non-thermal water vapor plasma at a pressure of 2 mbar in a CVD reactor, for example by Plasma Enhanced Chemical Vapor Deposition (PECVD). The PECVD reactor has a three-electrode configuration. A non-thermal water vapor plasma is ignited between two multi-hole graphite electrodes located above the electrode 15. The two graphite electrodes are 2.5 cm apart. A third electrode located under electrode 15, acting as a support, is connected to the negative pole of the power supply which is equipped with a voltmeter. When the power supply is off, it acts as a floating voltmeter, otherwise it can be used to generate controllable power by applying a negative bias to achieve a controllable ion flow and ion energy striking the electrode 15.

Water vapor is injected at a flow rate of 10 sccm and the pressure inside the reactor is of the order of 2 mbar. A plasma is created by applying a voltage of between 650 and 700 V between the two graphite electrodes of the reactor.

After plasma ignition, the voltage applied to the anode of the PECVD reactor is kept virtually constant between 400 and 420 volts with a current intensity between the two multi-hole electrodes of around 0.20 to 0.24 A. With this set of plasma parameters, the experiments were continued by modifying the exposure time which varied from 2 to 10 minutes.

A potential difference between the second and third electrode was added by applying a power of 1 to 5 W to the third electrode connected to electrode 15, allowing better control of the flow and energy of the ions bombarding electrode 15.

The size and density of the defects created can be controlled via the plasma exposure time and the plasma parameters (voltage and current density).

According to the embodiment, a method is also proposed for manufacturing a LIB 10. The method for manufacturing the LIB 10 comprises the step of obtaining an anode 3. This step may involve procuring the anode 3 or purchasing a commercial anode 3. The manufacturing method further comprises the step of assembling the LIB 10 by interposing the stack 11 of the two layers 111, 112 between the cathode 1 and the anode 3.

In a non-limiting embodiment, the LIB 10 comprises an electrolyte solution containing 1 M of lithium bis(trifluoromethanesulfonyl)imide (LiTFSi) and 0.25 M lithium nitrate (LiNO₃) in 1,3-dioxolane: 1,2-dimethoxyethane (DOL:DME) in a volume ratio of 1:1. Prelithiation of the anode 3 is achieved by cycling the anode 3 with the lithium metal in a button cell configuration. A piece of lithium, acting as an additional lithium source during discharge, can be placed on anode 3. The mass of silicon in the anode is balanced with the mass of sulfur in the cathode.

The LIB 10 is manufactured in a glove box under an argon atmosphere. The lithiated anode 3 is placed on the negative case and covered with the two layers 111, 112. The cathode 1 is placed on the separator 112 and is covered by a stainless steel spacer. A stainless steel spring is placed on the spacer to provide sufficient pressure and contact between all components. The LIB 10 is then sealed in a crimped button cell.

An alternative step to the cathode 1 pre-lithiation step described above is also proposed. This alternative step consists in covering the CNTs with lithium sulfide (Li₂S) during the step of the method according to the invention consisting in covering the CNTs 9 with the sulfur solution. The Li₂S cathode avoids the silicon pre-lithiation step. In addition, Li₂S has the advantage of having a lower density (1.66 g.cm⁻³) than sulfur (2.07 g.cm⁻³), so there is no need to reserve additional empty space for potential volume expansion during cycling.

According to a non-limiting embodiment, the step of obtaining electrode 15 may comprise be synthesizing electrode 15.

The synthesis method can be carried out on commercial aluminum (Al) or copper (Cu) foils, used as substrates 41, 42, with a thickness of between 10 and 50 μm.

A layer of aluminum oxide (Al₂O₃), between 10 and 50 nm thick, followed by a layer of iron (Fe), between 1 and 10 nm thick, are successively deposited on substrates 41, 42 in an electron-beam evaporator. Deposits (of aluminum and iron oxides) are made under high vacuum (of the order of 10-8 mbar). During deposition, the temperature of the substrates 41, 42 is maintained at 300° C. The process of heating the substrates is essential for a number of reasons: 1) ensures degassing of any impurities from the substrates, 2) allows diffusion of atoms to the surface of the pre-deposited alumina layer, and 3) promotes adhesion of the multi-layers with the substrates and also improves adhesion of the CNTs during their subsequent growth. Other catalysts, such as cobalt, nickel or alloys, can be used. The initial thickness and chemical nature of the catalyst determine the morphology of the resulting CNTs 9 (tube diameter and number of walls). In addition, the variation of CVD deposition parameters (pretreatment time between 1 and 5 minutes and/or gas composition and pressure), the total surface area of CNTs 9 and the density of CNTs 9 can be controlled and, consequently, the porosity (inter-tube distance) of the resulting vertically aligned mat of CNTs 9.

Then, the CNTs 9 are synthesized in a quadruple hot filament chemical vapor deposition (4HF-CVD) reactor. The main difference between a standard thermal CVD reactor and the 4HF-CVD reactor lies in the addition of four tungsten filaments at each gas inlet of the reactor. The presence of four tungsten filaments (two at each gas inlet) allows the growth of aligned CNTs 9 with an increased degree of uniformity in the diameter and length of the CNTs 9 and, above all, their synthesis over large areas.

The substrate 41, 42 coated with the catalyst layers (Al₂O₃ and Fe) is kept in a cooling zone until the reactor reaches a temperature of 600° C. and a pressure of 8 mbar. The substrate 41, 42 coated with the catalyst layers (Al₂O₃ and Fe) are moved to the deposition zone where no significant thermal gradient is present.

Catalysts are pre-treated with activated hydrogen gas (or atomic hydrogen) for 1 to 5 minutes. Hydrogen gas flows along two dedicated tungsten filaments which are heated to over 2000° C. (for an applied power of between 400and 500 W) at a flow rate of between 50 and 75 sccm and a reactor pressure of between 5 and 12 mbar. The atomic/activated hydrogen reduces the iron catalyst layer and creates punctual defects in the underlying layer of Al₂O₃ which will act as trapping sites for the formation of catalyst nanoparticles.

The actual growth of CNTs 9 is achieved by exposing the pre-treated substrate to a CH₄/H₂ gas mixture at a flow rate of 50 and 20 sccm respectively and at a reactor pressure of between 10 and 15 mbar. Growth times range from 5 to 120 minutes and allow CNT heights from 7 μm to 200 μm. CH₄ circulates along two dedicated powered filaments. The role of atomic hydrogen generation in this step is to prevent excess amorphous carbon deposition during the growth of CNTs 9. The growth time is proportional to the desired final length of the CNTs 9 while the catalyst is active, that is, level with the mat of aligned CNTs 9 obtained.

After the growth of the CNTs 9, the electrodes 15 are moved to the cooling zone at the end of the growth process and stored until the reactor has cooled down completely.

Generally, the diameter, number of walls and density of the CNTs 9 can be adjusted via the initial thickness of the catalyst layer, the chemical nature thereof (Fe, Co, Ni or alloys), the flow and composition of the gas precursors, the pressure and the duration of the pretreatment step.

Of course, the invention is not limited to the examples just described, and many adjustments can be made to these examples without going beyond the scope of the invention.

Additionally, the various features, forms, variants and embodiments of the invention may be combined with each other in various combinations as long as they are not incompatible or exclusive of each other.

In the claims:

1. A cathode for a lithium-ion battery comprising:
a layer of a conductive material arranged to collect the current flowing through the cathode, referred to as the substrate of the cathode;
a layer of aligned carbon nanotubes (CNTs) in electrical contact with the substrate of the cathode and mainly extending perpendicular to the substrate of the cathode;
solid sulfur which at least partially coats an outer wall of the CNTs; and
a solid layer of solid lithium sulfate (Li₂SO₄), which layer is referred to as the outer layer of Li₂SO₄, covering the layer of CNTs so as to form a stack of layers wherein the layer of CNTs is located between the substrate of the cathode and the outer layer of Li₂SO₄.

2. The cathode according to claim 1, comprising solid lithium sulfate (Li₂SO₄) encapsulating and/or enveloping, at least partially, the solid sulfur which coats the outer walls of the CNTs.

3. The cathode according to claim 1, wherein a mass loading of solid sulfur is greater than 1.5 mg/cm².

4. The cathode according to claim 1, wherein the outer layer of Li₂SO₄ has a thickness of less than 10 nm and greater than 3 nm.

5. A lithium-ion battery, referred to as LIB, comprising the cathode according to claim 1.

6. The LIB according to claim 5, comprising:
an anode based on silicon nanoparticles; and
a porous element arranged between the cathode and the anode.

7. The LIB according to claim 6, wherein the anode comprises:
a layer of a conductive material, referred to as the substrate of the anode, arranged to collect the current flowing through the anode;
a layer of aligned carbon nanotubes (CNTs) in electrical contact with the substrate of the anode and mainly extending perpendicular to said substrate of the anode; and
silicon nanoparticles which coat the outer wall of the CNTs.

8. The LIB according to claim 6, wherein a silicon mass loading of the silicon nanoparticles of the anode is greater than 2 mg/cm².

9. A method for manufacturing a cathode, said method comprising the steps of:
obtaining an electrode, referred to as the electrode obtaining step, comprising a layer of a conductive material, arranged to collect the current flowing through the cathode, referred to as the substrate of the electrode, from which extends, mainly perpendicularly, a layer of aligned carbon nanotubes (CNTs) in electrical contact with the substrate of the electrode; then
covering one face, referred to as the outer face, of the layer of CNTs, located on the side opposite to a face of the layer of CNTs in electrical contact with the substrate of the electrode, with a solution, referred to as the sulfur solution, comprising solid sulfur to form a coating of solid sulfur which at least partially coats an outer wall of the CNTs; and then
covering the outer face of the layer of CNTs with a solution comprising dissolved lithium sulfate (Li₂SO₄) to form a layer of solid lithium sulfate (Li₂SO₄) covering the layer of CNTs.

10. The method according to claim 9, wherein the sulfur solution comprises a solid sulfur powder, a polar solvent and carbon disulfide, a volume ratio between the carbon disulfide and the polar solvent is between 10 and 30%.

11. The method according to claim 9, comprising a step, referred to as plasma treatment, consisting in treating the CNTs of the electrode with a cold plasma and/or a water vapor plasma; the plasma treatment step is carried out prior to the step consisting in covering the layer of CNTs with the sulfur solution and subsequent to the electrode obtaining step.

12. The method according to claim 11, wherein the plasma treatment step further comprises acceleration, by polarization, of all or some of the species present in the plasma towards the electrode.

13. The method according to claim 9, wherein the step of obtaining the electrode comprises a step of synthesizing the CNTs on the substrate of the electrode by hot-filament chemical vapor deposition, said synthesis step comprises:
arranging the substrate of the electrode equidistant from four aligned hot filaments; and
flushing a gas, comprising precursors, parallel to the hot filaments.

14. The method according to claim 13, comprising, prior to the step of synthesizing CNTs, a step of depositing a layer, referred to as a barrier layer, of aluminum oxide (Al₂O₃) with a thickness of between 5 and 80 nm on the substrate of the electrode and an iron layer, referred to as a catalyst layer, deposited on the barrier layer, with a thickness of between 1 and 30 nm.

15. A method of manufacturing a lithium-ion battery, referred to as LIB, comprising the steps of:
implementing the method for manufacturing a cathode according to claim 9;
obtaining an anode for the LIB; and
assembling the LIB by interposing a porous element between the cathode and the anode.
